(19) United States
(12) Patent Application Publication
(10) Pub. No.: US 2010/0018910 A1
(43) Pub. Date: Jan. 28, 2010

(54) SCREENING MACHINE SCREEN PANEL

(75) Inventor: Brady P. Ballman, Loveland, OH (US)

Correspondence Address: WOOD, HERRON & EVANS, LLP, 2700 CAREW TOWER, 441 VINE STREET, CINCINNATI, OH, 45202, US

(73) Assignee: ROTEX GLOBAL, LLC, Cincinnati, OH (US)

(21) Appl. No.: 12/572,502

(22) Filed: Oct. 2, 2009

Related U.S. Application Data
(62) Division of application No. 11/382,353, filed on May 9, 2006.
Application No. 11/382,353 is a continuation-in-part of application No. 11/295,259, filed on Dec. 6, 2005, now abandoned.

(51) Int. Cl. B07B 1/30

(52) U.S. Cl. 209/341; 209/352

(57) ABSTRACT

A screening machine of the type used to separate or classify mixtures of solid particles of different sizes includes a fixed base and a perforate screen mounted for movement relative to the base during a screening operation. The screens are pre-tensioned and mounted in a perimeter frame for separating various granular and particulate material. The frame is slid into the side of the machine in a direction parallel with two opposing bevel lips at the ends of the frame which mate in the screening machine with a complementary channel such that when the screen is raised into sealing contact in the screening machine, the bevel ends of the screen panel frame align the screen panel in the machine. The bevels on the screen panel frame provide a positive sealing surface for contact with the adjacent portions of the channel to prevent product from escaping off of the screen during use. The sealing contact of the screen panel is enhanced by a seal member on the screen panel.

This is a divisional of and claims priority to U.S. patent application Ser. No. 11/382,353, filed May 9, 2006, which was a continuation-in-part of and claimed priority to U.S. patent application Ser. No. 11/295,259, filed Dec. 6, 2005. Each of these prior applications is hereby incorporated by reference in its entirety.

### BACKGROUND OF THE INVENTION

This invention relates to screening machines of the type used to separate or classify mixtures of solid particles of different sizes. The invention also relates to screening machines of the type used for liquid/solid separations, i.e., for separating solid particles of specific sizes from a liquid in which they are carried. More particularly, the invention relates to an improved screen panel for use within the screening machine.

In screening machines of the type described, a screen (which may be woven, an aperture plate or another design) is mounted in what is often called a “screen frame” or “screen deck” which includes a supporting peripheral frame around the perimeter of the screen. Some screens are tensioned when they are installed in the screening machine and other screens are pre-tensioned in a frame prior to being installed in the machine. Typically associated with the screen deck are other material handling elements which are moved with the screen and form walls or partitions above or below the screen for containing the liquid and/or particulate materials adjacent to the screen and directing them to appropriate outlets. These elements may comprise a top cover and a pan beneath the screen deck. In the case of screening machines with multiple screens or deck units, spacer pans or frames are provided between the multiple screens.

The screens are often removed from the screening machines for cleaning, replacement, readjustment or installation of a screen of a different mesh size or the like. The screen is releasably mounted to a carrier, table or box to which vibratory motion is imparted, typically by one or more eccentric motors or other means of excitation. The carrier, table or box is referred to herein as a “vibratory carrier”. The vibratory carrier may be moved in oscillatory, vibratory, gyratory, gyratory reciprocating, fully gyratory, rotary or another type of motion or combinations thereof, all of which are herein collectively referred to as “vibratory” motion or variations of that term.

In large commercial screening machines, the weight of the various components including the screen assembly carried by the vibratory carrier, and the weight of the material being processed on the screen assembly may total several hundred pounds or more. Screening machines which tension the screen, as opposed to those utilizing pre-tensioned screens, include the added weight associated with the screen tensioning mechanism and related components. This presents a very substantial inertial mass which resists the changes of motion applied thereto by the vibratory drive acting through the vibratory carrier. As a result of these inertial forces, a relative motion may exist between the vibratory carrier and the screen assembly. Typically, the screen assembly and vibratory carrier are each constructed of metal which could result in significant noise, wear and damage due to the relative motion or rubbing action there between. The resulting impact forces between the screen assembly and vibratory carrier significantly increase the stresses on the components and reduce their useful life.

Reducing the metal-to-metal contact minimizes the wear on the various metal components and the noise associated with the operation of the screening machine. Currently, certain screen assembly designs may not be sealed or secured relative to the remainder of the screening machine, particularly in larger screening machines. This results in the above-described metal-to-metal contact between the screen assembly and the remainder of the screening machine and prevents the screening of very fine material, such as sand or the like. The lack of an adequate seal between the screen panel carrying the material being screened and the remainder of the screening machine allows for the material to escape off of the screen panel without being screened, thereby minimizing the effectiveness of the screening operation particularly for fine and extra fine materials.

The screens in larger screening machines are typically inserted and/or removed from the machine in a generally horizontal, longitudinal direction typically through an opening or slot at the head or foot end of the machine. This method of installation and removal of the screen is detrimental to known sealing arrangements because a seal on the screening machine vibratory carrier which would engage the screen panel could be torn or damaged during the installation/removal of the screen. In other screening machines, the screen is inserted vertically, typically from the top of the machine. Access to the screens from the top of the machine or the longitudinal ends is often very inconvenient and difficult.

### SUMMARY OF THE INVENTION

The above-described and other problems with prior art screening machines and associated screen panels have been resolved by this invention. Screening machines according to one embodiment of this invention utilize one or more pre-tensioned screens mounted in a perimeter frame for separating various granular and particulate material. One aspect of this invention is the profile or contour of opposite ends of the perimeter frame for the screen. The mesh screen is mounted to a rigid perimeter frame. The screen is pre-tensioned in the frame as opposed to screens which are stretched or tensioned during the screening machine set up. The frame is slid into the side of the machine in a direction parallel with two opposing contoured profile ends of the frame. In one embodiment, the profile of the frame along each end includes a downwardly directed bevel relative to the plane of the screen. The profile or contour of these ends align with and mate in the screening machine with a complementary channel such that when the screen is raised into sealing contact in the screening machine, the bevel ends of the screen panel frame align the screen panel in the machine through a comparably dimensioned and configured channel on the screening machine. Likewise, the bevels on the screen panel frame provide a positive sealing surface for contact with the adjacent portions of the channel to prevent product from escaping off of the screen during use.

The seal between the screen panel and the vibratory carrier and/or other parts of the screening machine that mate with the screen panel has been enhanced in one embodiment of this invention by a seal member on the screen panel. The seal member can run the entire perimeter of the screen panel or just selected ends or edges. Another advantage of the seal member is that in one embodiment, it encapsulates the free, often rough, edge of the screen material to avoid injury during handling of the screen panel.

Therefore, according to this invention, the screening operation is much more efficient, effective, safer and more easily accomplished while offering significant advantages in screen service life, installation and removal.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a perspective view of an exemplary screening machine and associated screen panel being installed therein according to one embodiment of this invention;

FIG. 2 is a perspective view of the screen panel of FIG. 1;

FIG. 3 is a top plan view of the screen panel of FIG. 2;

FIG. 4 is a side elevational view of the screen panel of FIG. 2;

FIG. 5A is a side elevational view of a portion of the screening machine of FIG. 1 and a screen panel inserted therein prior to a screening operation;

FIG. 5B is a view similar to FIG. 5A with the screen panel engaged with a screen panel carrier according to one aspect of this invention;

FIG. 6 is a top plan view of a second embodiment of the screen panel according to this invention;

FIG. 7 is a perspective, enlarged view of a portion of the screen panel of FIG. 6;

FIG. 8A is a side elevational view of a portion of the screening panel of FIG. 6 inserted into a screening machine and prior to a screening operation;

FIG. 8B is a view similar to FIG. 8A with the screen panel engaged with a screen panel carrier according to one aspect of this invention;

FIG. 9 is a perspective view of one system and associated method for adding a seal member to a screen panel according to one embodiment of this invention;

FIGS. 10A and 10B are sequential views of another system and method for adding a seal member to a screen panel according to this invention;

FIG. 11A is a perspective view of a portion of a further alternative embodiment of a screen panel according to this invention; and

FIG. 11B is a view similar to FIG. 11A with an end of the screen panel deflected downwardly.

### DETAILED DESCRIPTION OF THE INVENTION

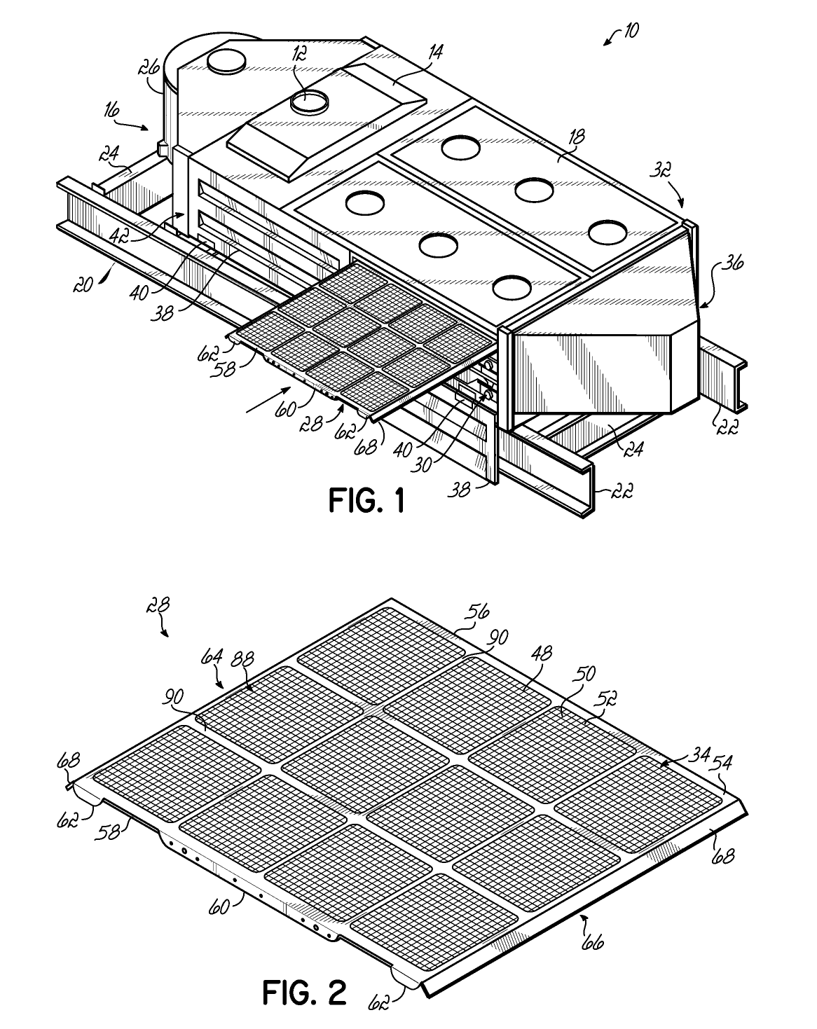

Referring to FIG. 1, an exemplary embodiment of a screening machine 10 in which this invention may be used is shown. Screening machines of many types are sold commercially by Rotex, Inc. of Cincinnati, Ohio, the assignee of this invention. However, this invention is not limited to any particular type of screening machine design or application and the machine shown and disclosed herein is shown for illustrative purposes.

The screening machine 10 includes an inlet port 12 near an inlet section 14 proximate a head end 16 of the machine 10. The screening machine 10 may also include a top cover 18 in any one of a variety of forms. Particulate or other material to be screened is fed into the inlet port 12 from a hopper (not shown) for screening and processing by the machine 10.

The screening machine 10 is supported structurally by a base frame 20 including beams 22 connected together by laterally oriented struts 24 on each end of the screening machine 10. The screening machine 10 includes an electric motor 26 coupled to a drive weight (not shown) to impart an oscillatory, vibratory, gyratory, gyratory reciprocating, fully gyratory, other motion or combinations thereof (herein collectively referred to as “vibratory” motion or variations of that term) to at least the head end 16.

Within a screening chamber of the screening machine 10, one or more screen panels 28 are each mounted in combination to form one or more screen decks 30 to receive the material being screened from the feed chute 12 at the head end 16 of the machine 10. The screen panels 28, are mounted on slightly sloping planes (approximately 4E) with the head end thereof being slightly elevated relative to a foot end so that during the screening process the material advances, in part by gravity, over the screen panels 28 toward the foot or discharge end 32 of the machine 10. Even though the screen panels 28 of the screening machine 10 may be on a slightly sloping plane, to provide a reference for the purposes of clarity herein, these components will be considered to be generally horizontal and the direction perpendicular or orthogonal to the screen panels 28 will generally be referred to as a vertical orientation, direction or attitude. The direction of travel of the material being screened from the head end to the foot end across the screen panels 28 is referred to as the longitudinal direction and the perpendicular orientation extending from side to side on the screen panels is a lateral direction.

In the embodiment of the screening machine 10 shown in FIG. 1, upper and lower screen decks 30 each include four screen panels 28 mounted generally coplanar with each other in the associated screen deck 30. Accordingly, as the material to be screened is deposited from the inlet port 12 onto the upper screen deck 30, the vibratory motion of the screening machine 10 advances the material longitudinally across the top of the screen panels 28 of the upper screen deck 30 toward the foot end 32. Appropriately sized and configured material passes through the upper screen deck 30 and falls onto the lower screen deck 30. The screen panels 28 of the upper screen deck 30 may include a fine mesh screen material 34 adjacent the inlet port 12 through which dust and other fine particulate matter passes for collection and discharge. Certain material also passes through the upper screen deck 30 and is deposited on the lower screen deck 30. Therefore, the lower screen deck 30 is included to provide an additional separating mechanism for the appropriately sized particles to pass through the second lower screen deck 30 for collection in the lower pan (not shown) and discharge through an outlet or exit section 36.

The unacceptably sized particles remain atop the first upper screen deck 30 and fall off the terminal edge thereof into a collection basin for discharge through the outlet section 36. Material that passes through the upper screen deck 30 and remains atop the lower screen deck 30 falls off the terminal edge thereof and into the collection basin for discharge through a reject port (not shown). The discharge and reject ports are separated by a baffle (not shown) to keep the classified particles separate from one another.

Referring to FIG. 1, one or more doors 38 are each pivotally connected by a hinge 40 to a lateral side 42 of the screening machine 10. When opened, the doors 38 provide access for insertion and removal in the lateral direction of the screen panels 28. It will be appreciated that although one side 42 of the screening machine 10 is shown in FIG. 1, additional doors on the opposite side of the screening machine 10 may also be provided. Advantageously, the screen panels 28 are inserted laterally or perpendicularly to the longitudinal direction of travel of the material being screened in the screening machine 10 from the head end 16 to the foot end 32 of the machine 10.

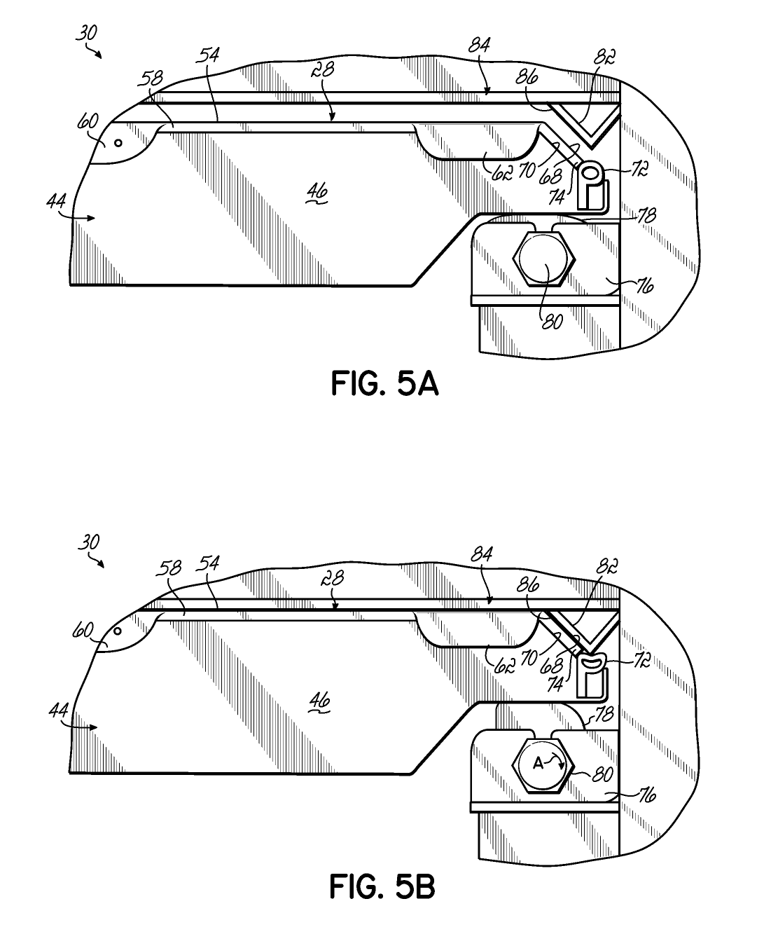

As shown generally in FIG. 5A, when the screen panel 28 is inserted into the screening machine 10, it is supported on a vibratory carrier 44. In one embodiment, the vibratory carrier 44 may include a ball tray 46 capturing a number of balls or other agitation producing members (not shown) which repeatedly impact the screen panel 28 to dislodge particulate material that might accumulate on the screen material 34 and inhibit occlusion of the screen material 34 as is well known in the art.

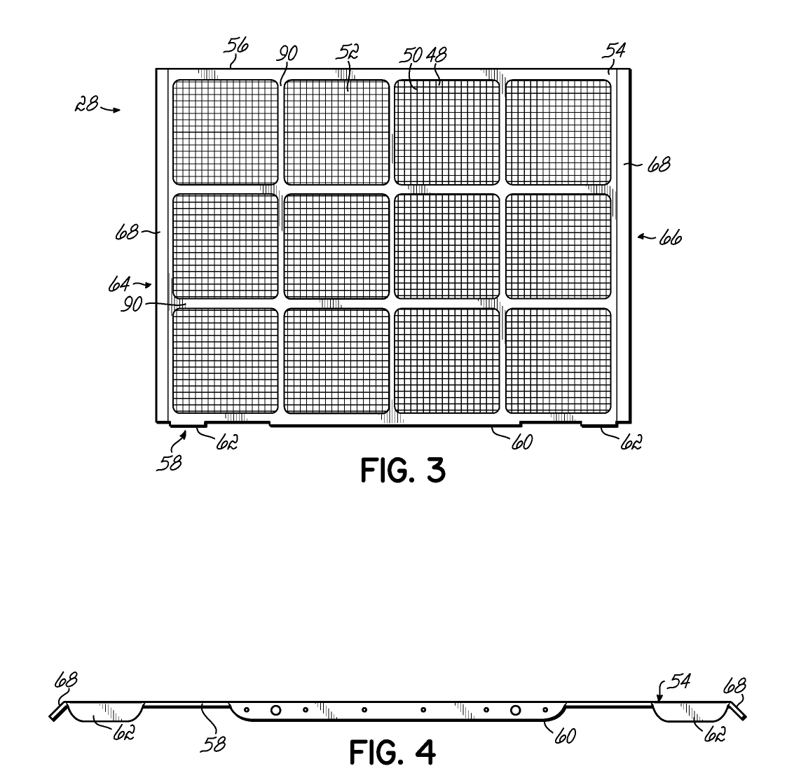

Referring to FIGS. 2-4, one embodiment of the screen panel 28 according to this invention includes a generally perforated mesh screen material 34 including a number of intersecting longitudinal 48 and lateral 50 threads, wires or strings which are oriented orthogonally to each other to provide appropriately sized and configured openings 52 in the mesh screen material 34 to prevent/permit the passage particulate material there through. The screen panel 28 includes a generally rigid perimeter frame 54 having a leading side edge 56 opposite from a trailing side edge 58. In one aspect, the screen material 34 of the screen panel 28 of this invention does not require tensioning by the screening machine 10 upon installation into the screen deck 30. Many prior screening machines tension the screen mesh material or pull it taught during the installation process. The screen mesh material 34 of the screen panel 28 according to this invention does not require tensioning and in that sense is considered pre-tensioned in that it is mounted in the screen panel frame 54 in a ready-to-use state.

The panel 28 may be manufactured by a variety of processes, one of which utilizes a bare metal frame which is dipped into an epoxy and allowed to air dry. The epoxy is hard to the touch but has not cured. The frame 54 with dry epoxy is then placed on a table with mesh screen material 34 on top. This stack-up is then bonded together with a heat press for a few minutes. The edges are then cleaned up with a hand grinder, if necessary.

A further benefit of this aspect of the invention is that the process leaves the panel 28 feeling tensioned although no time or fixture is required to pull (tension) the screen material 34 prior to bonding it to the frame 54 or when installing the screen frame panel into the screening machine 10. The new panel 28 design incorporates this approach such that open area is maximized but the tension level is comparable to known tension techniques, such as spring clips.

The leading side edge 56 of the screen panel frame 54 is typically inserted laterally into the screening machine 10 while a user or operator grasps the trailing side edge 58 for manipulation. In particular, a downwardly turned elongate handle 60 is formed on the trailing side edge 58 of the screen panel 28. In one embodiment, the handle 60 is oriented approximately 90E relative to the plane of the screen panel 28 and provides a convenient and easy access for the user or technician to grasp or manipulate the screen panel 28. Additionally, the handle 60 or adjacent surfaces of the screen panel frame 54 provide a convenient location for identifying indicia and labels indicating various service parameters, design characteristics and other aspects of the screen panel 28.

One or more tabs 62 each located proximate a head end 64 or a tail end 66 of the screen frame 54 are located along the trailing side edge 58 of the frame. The tabs 62 are each oriented approximately 90E relative to the plane of the screen panel 28 and along with the handle 60 provide a convenient location for the user or technician to grasp and manipulate the screen panel frame. Likewise, upon insertion of the screen panel 28 into the screening machine 10, the tabs 62 and handle 60 provide a detent when juxtaposed against the vibratory carrier 44 for proper orientation and location of the screen panel 28 in the screening machine 10.

Another aspect of the screen panel 28 and associated frame 54 according to this invention are beveled edges or lips 68 along the longitudinal head end 64 and/or foot end 66 of the screen panel frame 54. Each bevel 68 is oriented approximately 45E relative to the upper surface or plane of the screen panel 28 and extends substantially the entire width of the frame 54. While the bevel 68 are shown along both the longitudinal head and foot ends 64, 66 of the screen panel frame 54, one of ordinary skill in the art will readily appreciate that the bevel edge 68 may be provided at either or both of the head and foot ends 64, 66 within the scope of this invention. In the embodiment of the screen panel 28 shown in FIGS. 5A and 5B, the beveled edge(s) 68 an integral part of the screen panel frame 54, which is typically a metal material. Therefore, the orientation of the edge(s) 68 relative to a remainder of the screen panel frame 54 is fixed or rigid.

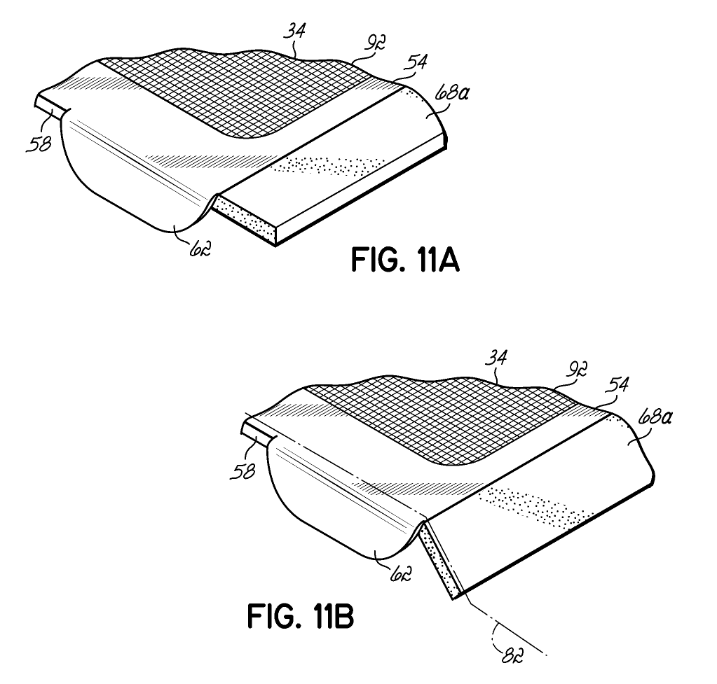

An alternative embodiment is shown in FIGS. 11A and 11B in which the edge(s) 68a are bendable or capable of deflection in the normal course of use relative to the remainder of the screen panel frame 54. The edge(s) 68a may be made of a rubber or similar compound and extend in a coplanar direction relative to a central region 92 of the screen panel 28 as shown in FIG. 11A. When the screen panel 28 is installed in the screening machine 10, the edge(s) 68a deflect downwardly as shown in FIG. 11B to mate with the vibratory carrier 44 and/or other portions of the screening machine 10. The rubber material of the edges 68a may also provide a sealing benefit when installed in the screening machine 10 and accommodate a variety of different geometries associated with the screening machine 10 in that the edge(s) 68a are capable of deflecting or bending as needed.

Referring to FIGS. 5A and 5B, the configuration of the screen panel frame 54 relative to the remainder of the screening machine 10 will now be described. The downwardly turned bevel edges 68 along the head and foot ends 64, 66 of the screen panel frames 54 are supported by a similarly inclined face 70 of the vibratory carrier 44 as shown in FIG. 5A. The carrier 44 also includes a compressible ball tray seal member 72 juxtaposed to the terminal edge 74 of the bevel edge 68 and mounted in the carrier 44. Likewise, the lower surface of the screen panel frame 54 is supported along a similarly configured profile of the carrier 44 as shown in FIG. 5A.

The screening machine 10 includes a bracket 76 in which a rotational cam 78 is seated to support the carrier 44. The rotation of the cam 78 is accomplished by an actuator 80 accessible to the operator or technician when the door 38 of the screening machine 10 is open. One known mechanism suitable for use with this invention to raise/lower the carrier 44 and screen panel 28 is disclosed in Rotex' U.S. Pat. No. 6,070,736 which is incorporated by reference herein. The screening machine 10 also includes a downwardly depending channel or seal cap 82 initially spaced from the bevel lip 68 of the screen frame 54 as shown in FIG. 5A.

Upon rotation in the direction of arrow A of the actuator 80, the cam 78 is rotated thereby raising the carrier 44 and screen panel 28 supported thereon upwardly to sealing engagement with an upper portion 84 of the screen deck 30 as shown in FIG. 5B. As the carrier 44 supporting the screen panel 28 is raised, a face 86 of the seal cap channel 82 is juxtaposed against the bevel lip 68 of the screen panel 28 and the seal 72 is compressed against the channel 82. As a result, the portion of the screen deck 84 and upper surface of the screen panel frame 54 are sealed to prevent and inhibit the discharge of material being screened. Due to the design and configuration of the screen panel frame 54 and associated screen deck 30, the seal 72 and associated components are neither damaged nor compromised during the lateral installation and removal of the screen panel 28 thereby extending the service life of the associated components while maintaining effective sealing and associated screening operations. The orientation of the seal 72 is generally parallel with the lateral direction in which the screen panel is inserted and removed from the machine 10.

The bevel edges 68, 68a on two opposite ends in conjunction with the lift system described in U.S. Pat. No. 6,070,736 permits insertion and proper location, alignment, sealing, and securing of the screen panel 28 to the screening machine 10 while maintaining a smooth transition (no bumps or wear points). This invention offers a screen panel 28 that is pre-tensioned, ready to use, lightweight, standardized in size to lower cost, simple design, mass producible, easy to handle, nestable for storage and shipping. The bevel lip 68, 68a also acts as a seal holder for reusable seal strips 72.

Referring to FIGS. 1-3, the screen panel 28 of this invention includes a number of smaller cells 88 defined around the interior of the perimeter frame 54 by plurality of transverse and longitudinally extending ribs go. Because the screen material 34 is flat and pressed, smaller cells 88 result in greater tension in the screen mesh material 34 since it has very little length and is held on both ends and it cannot deflect for a given load. The orientation of the ribs go may be skewed or not aligned with the orientation of the openings 52 defined by the threads 48, 50 of the screen material 34. Alternatively, the ribs go and threads 48, 50 of the screen material may be aligned with each other in the lateral and longitudinal direction. In one embodiment of the screen panel 28, the wire mesh screen material 34 is not bonded directly to the ribs go, only the perimeter frame 54. Silicone may be used either as an adhesive to bond the screen material 34 to the frame 54 and/or as a buffer between the screen material 34 and another suitable adhesive known in the industry. It is believed that the silicone retards fatigue of the screen material 34 in use. As such, the service life of the screen panel 28 is extended and the economic benefit of this invention is maximized. It is expected that this general design provides improved throughput, service live and screening accuracy.

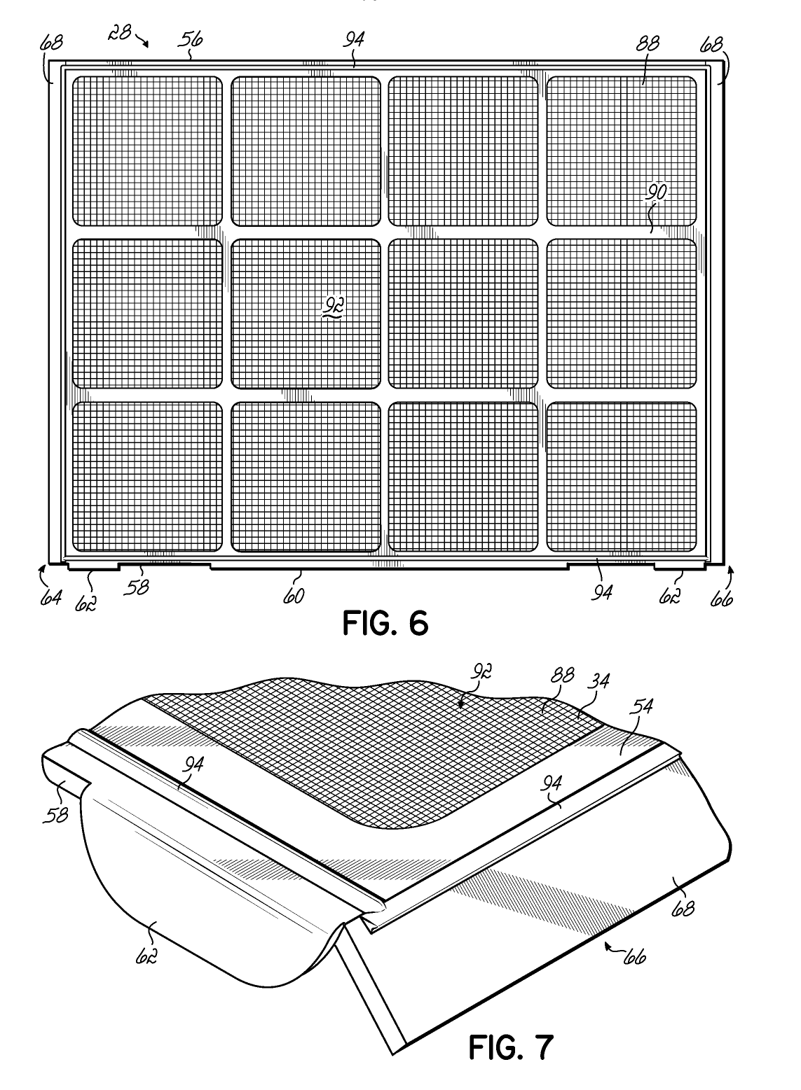

An additional aspect of this invention is shown in FIGS. 6-9. The screen panels 28 of FIGS. 6 and 7 includes a seal member 94 extending adjacent to the perimeter of the screen panel 28. In one embodiment, the seal member 94 extends across both the head end 64 and tail end 66 of the screen frame 54. In other embodiments, the seal member 94 may extend entirely around the screen frame 54 including the head end 64, tail end 66, leading side edge 56 and trailing side edge 58 as shown in FIGS. 6 and 7. The seal member 94 provides an additional measure of increased sealing contact for the screen panel frame 28 when mounted in the screening machine 10. This has proven to be an added benefit when extra fine materials are being screened in the screening machine 10 which might otherwise find their way past the existing sealing surfaces between the screening panel and the screening machine components.

In the embodiment shown in FIGS. 6 and 7, the seal member 94 along the leading side edge 56 and trailing side edge 58 has a generally semi-circular profile and is located on the upper generally planar central region 92 of the screen frame 54. The portion of the seal member 94 along the head end 64 and tail end 66 of the screen frame 54 is preferably positioned at the juncture between the beveled edge 68 and the central region 92 of the screen frame 54 as shown in FIG. 7. Preferably, the upper surface of the seal member 94 along the beveled edges 68 is generally coplanar with the upper surface of the central region 92 of the screen frame 54. The profile of the seal member 94 along the trailing and leading side edges 56, 58 may be compressed during installation of the screen panel 28 into the screening machine 10 to compensate for gaps from stack-up tolerances and the like during installation.

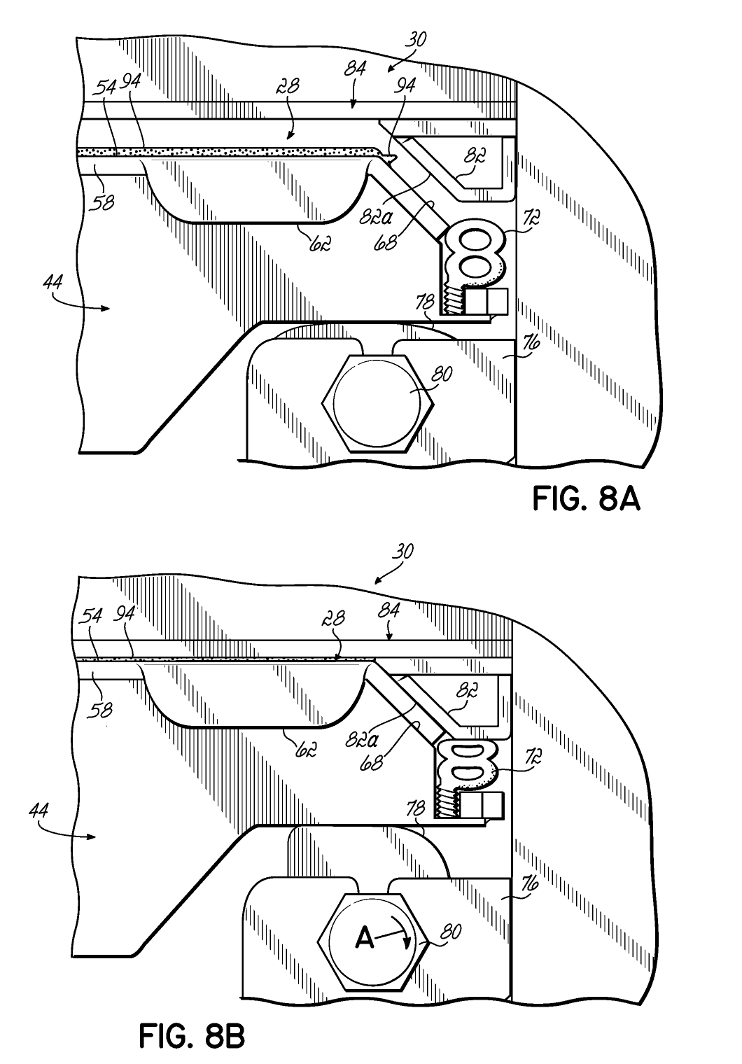

Advantageously, the position and configuration of the seal member 94 at the head end 64 and tail end 66 of the screen frame 54 fill a void or gap created by the radius at the juncture between the screen panel frame 54 and the beveled edge 68 when the screen panel 28 is inserted into the screening machine 10. As shown in FIGS. 8A and 8B, the profile of the seal member 94 along the beveled edge 68 seals a void when the screen panel 28 is inserted into the screening machine 10 created at the juncture between the screen panel inclined edge 68 and the seal cap channel 82 of the screening machine 10. A 45E inclined surface 82a of the seal cap 82 mates with the screen panel beveled edge 68 when the actuator is rotated in a direction of arrow A (FIG. 8B) to raise the carrier 44 and screen panel 28 supported thereon upwardly into sealing engagement with the seal cap 82 and associated portions of the screening deck 30. The seal member 94 greatly improves sealing when the screen panel 28 is installed in the screening machine 10 to prevent material from entering the ball tray seal 72 area.

An additional advantage of the seal member 94 according to the invention shown in FIGS. 6-7 is that the screen material 34, which is mounted to the perimeter frame 54, may include rough or frayed edges 34a when the screen material 34 is cut to fit the frame 54. In many instances, the screen material 34 is a wire or metal mesh and the individual threads 48, 50 present a sharp or frayed edge 34a outside of the cells 88 of the screen frame 28. Such sharp edges 34a may present an injury hazard to the users, operators and handlers of the screen panel 28. Since the seal member 94 is located outside of the cells 88 and the active portion or central region 92 of the screen material 34, these frayed or rough edges 34a may be encapsulated by the seal member 94 along the leading and trailing edges and/or the head and tail ends of the screen panel 54. The seal member 94 may encapsulate the cut edges 34a of the wire or screen material 34 without an additional process step or added cost to grind the excess screen material flush with the remainder of the screen panel 28 components.

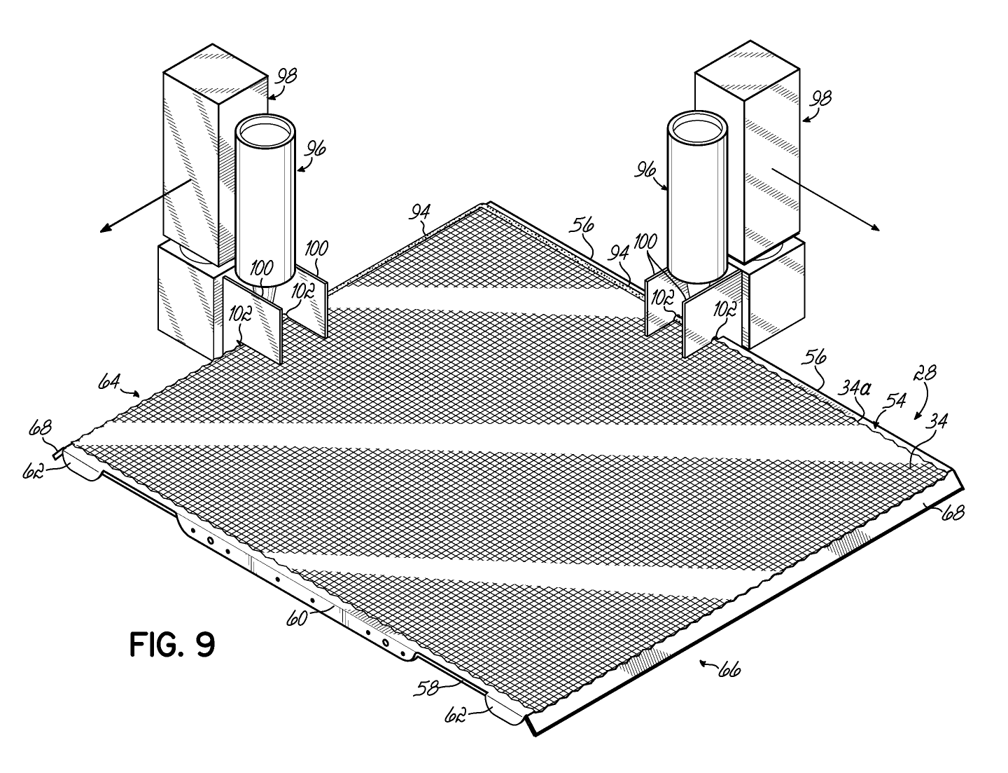

Referring to FIG. 9, one embodiment for applying the seal member 94 to the screen panel 28 according to this invention is shown. The seal member 94 may be a silicone or similar compound and dispensed from one or more cartridges 96 which are mounted in a servo-controlled or otherwise programmed delivery device 98 which advances in a uni-directional or bi-directional orientation relative to the screen panel 28. The material being dispensed from the cartridge 96 may be formed into the appropriate profile after it is applied to the screen panel 28 by leading and/or trailing scraper plates 100 mounted to the delivery device 98 and including a profile or contoured edge 102 which forms the dispensed seal material into the appropriate seal member 94 profile on the screen panel. As shown in FIG. 9, the rough edge 34a of the screen material 34 may be encapsulated by the bead formed into the seal member 94 thereby encapsulating any rough edges or wires of the screening material 34 while likewise forming the seal member 94 on the screen panel 34.

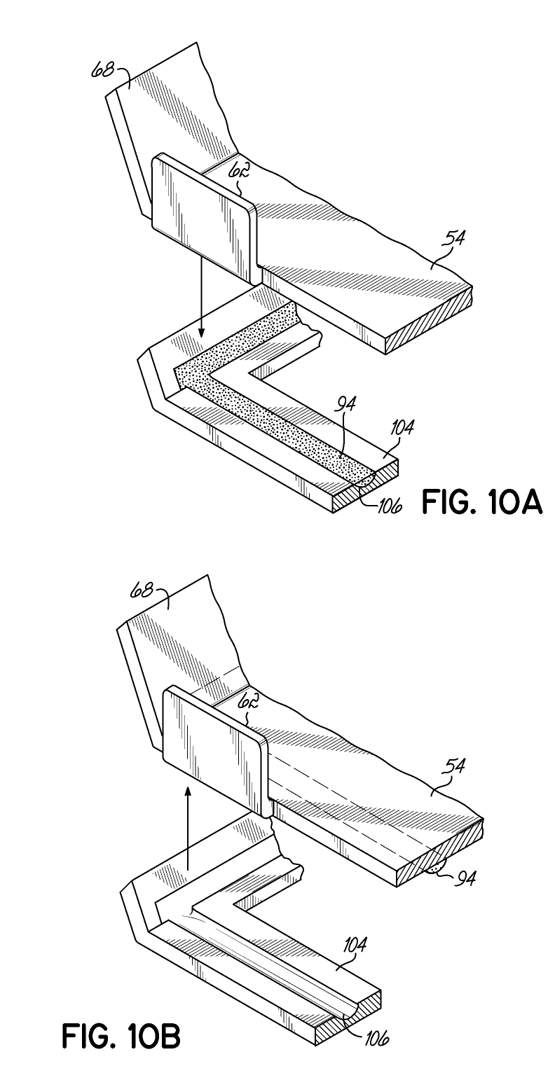

In an alternative embodiment, the seal member 94 may be formed according to FIGS. 10A-10B in which a jig 104 has a recessed groove 106 into which the seal material is deposited. The profile of the groove 106 defines the profile of the resulting seal member 94. The screen panel frame 54 is then mated with the jig 104 and the seal member material at which time the seal member material is transferred to the screen panel frame 54 as shown in FIG. 10B. The jig 104 and appropriate portions of the groove 96 may have a release coating such as Teflon® or the like to promote the release of the seal member bead from the jig 104 and onto the screen panel 28.

From the above disclosure of the general principles of the present invention and the preceding detailed description of at least one preferred embodiment, those skilled in the art will readily comprehend the various modifications to which this invention is susceptible. Therefore, we desire to be limited only by the scope of the following claims and equivalents thereof.

We claim:

1. A screen panel for a screening machine comprising:
a frame having a plurality of cross-members and a rigid external inclined end; and
a screen material securably attached to the frame.

2. The screen panel of claim 1, further comprising:
a seal member disposed on the rigid external inclined end.

3. The screen panel of claim 1, wherein the screen material is pre-tensioned to the frame.

4. The screen panel of claim 1, wherein the rigid external inclined end comprises a substantially continuous curved portion.

5. The screen panel of claim 4, wherein the substantially continuous curved portion comprises an included angle.

6. The screen of claim 1, wherein the frame further comprises:
a top portion; and
a bottom portion;
wherein the rigid external inclined end forms the bottom portion; and
wherein the screen material is securably attached to the top portion.

7. The screen panel of claim 1 wherein the screen panel is adapted for individual installation into and removal from the screening machine.

8. The screen panel of claim 1 wherein the screen panel is not adapted to be mated with a similar screen panel in the screening machine.

9. The screen panel of claim 1 wherein each of a pair of spaced ends of the frame is inclined relative to the screen material substantially over the entire extent of the frame end.

10. The screen panel of claim 1 wherein each of a pair of spaced ends of the frame is substantially uniform configuration over its entire extent and the spaced ends are substantially mirror images of each other.

11. A screen panel adapted to be inserted into a vibratory screening machine to screen particulate material deposited onto the screen panel, the screen panel comprising:
a perimeter frame having spaced sides and spaced ends;
a perforate screen material mounted to the peripheral frame adapted to separate the particulate material deposited thereon advancing in a generally longitudinal manner between the spaced ends of the frame;
wherein the screen material is generally planar and at least one of the ends is inclined relative to the screen material; and
a seal member mounted to the perimeter frame and adapted to seal the screen panel against an adjacent component of the screening machine to inhibit the particulate material from advancing off of the upper surface of the screen panel.

12. The screen panel of claim 11 wherein the seal member is positioned proximate a juncture between the inclined end and the remainder of the screen panel.

13. The screen panel of claim 11 wherein the inclined end is oriented downwardly relative to the screen material.

14. The screen panel of claim 11 further comprising:
a plurality pockets within the perimeter frame;
wherein the screen material is bonded to the perimeter frame and the seal member encapsulates at least a portion of an edge of the screen material.

15. The screen panel of claim 14 wherein the seal member extends around the entirety of the perimeter frame.

16. The screen panel of claim 10 wherein the screen panel is adapted for individual installation and removal into and from the vibratory screening machine.

17. The screen panel of claim 10 wherein the screen panel is not adapted to be mated with a similar screen panel in the screening machine.

18. The screen panel of claim 10 wherein each of the spaced ends is inclined relative to the screen material substantially over the entire extent of the end.

19. The screen panel of claim 10 wherein each of the spaced ends has a substantially uniform configuration over its entire extent and the spaced ends are substantially mirror images of each other.
